(19) United States
(12) Patent Application Publication
(10) Pub. No.: US 2007/0147608 A1
(43) Pub. Date: Jun. 28, 2007

(54) Random binary sequence generator

(76) Inventors: Jean-Francois Mainguet, Grenoble (FR); Fabrice Francioli, Bons En Chablais (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/579,724

(22) PCT Filed: Nov. 8, 2004
(86) PCT No.: PCT/EP04/52861

§ 371 Date: May 17, 2006

(30) Foreign Application Priority Data
Nov. 18, 2003 (FR) 03 13491

(51) Int. Cl. H04L 9/00

(52) U.S. Cl. 380/46

(57) ABSTRACT

According to the invention, the sequence is produced from a fingerprint sensor and an analog-to-digital converter. The random binary sequence is produced from low order bits from the converter. Said sensor comprises a matrix of preferably pyroelectric detectors. The order of the bits is scrambled by a reorganization circuit, and means are provided for balancing the distribution of 0 and 1 bits in the sequence produced.

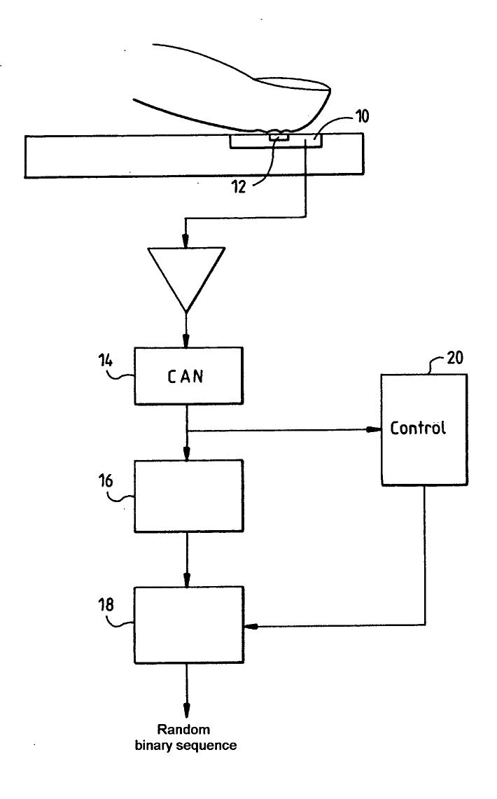

### FIELD OF THE INVENTION

The invention relates to the generation of random numbers or binary sequences, used mainly for cryptographic applications: many encryption software packages require the generation of a key that is as random as possible.

### BACKGROUND OF THE INVENTION

The purely algorithmic random number generators are in fact pseudo-random number generators; these numbers are not sufficiently random, as is demonstrated by tests used to measure the more or less random nature of sequences that have all the appearance of being random but which are not totally random.

To make binary sequences more random, the involvement of a human operator has already been proposed, with that operator required to perform electronically recorded random movements: an example of random number creation for an encryption software package consists in asking the user, sitting at the computer, to make arbitrary manual movements with the mouse; these movements are recorded and used to define a random sequence. However, experience shows that the sequence is still not sufficiently random.

There are even generators based on a physical source of random events, such as thermal noise. This physical source is applied to a formatting circuitry which converts it into a random sequence. These generators are unfortunately not very good statistically, because correlations often appear, linked to external conditions; for example, the 50 Hz or 60 Hz frequency of the electricity network used to power the equipment is reflected in residual form in the electronic circuits and generates a clearly non-random component in the supposedly random sequence.

It is also possible to envisage combining a pseudo-random generator and a random physical source, the physical source generating a momentary “seed” for starting the pseudo-random generator which takes over the process of generating the bits of a sequence. However, it is then necessary to use a relatively complex system to obtain this combination between the physical source and the pseudo-random generator.

### SUMMARY OF THE INVENTION

The object of the present invention is to propose a new type of random generator based on a physical source, which intrinsically presents a strongly random nature and which does not require, or practically does not require, a pseudo-random generator because the sequences of bits generated are already satisfactory from the viewpoint of most statistical tests.

The invention proposes a random sequence generator including, as the main element for generating a physically-originated random sequence, a fingerprint sensor with a matrix of individual detectors, this sensor including an analog-to-digital converter for converting the voltage levels detected by the individual detectors into digital form, and the low order bits of this conversion being used to form the bits of the pseudo-random sequence.

The sensor is preferably a scanning sensor, the matrix of which is made up of a few rows of numerous detectors, used to detect a fingerprint when a finger is swiped over the surface of the sensor. Such a sensor is disclosed in patent FR-A-2 749 955.

The sensor is preferably a sensor in which the individual detectors are pyroelectric cells.

The use of a fingerprint sensor as random generator is particularly indicated by the fact that the target applications (in particular encryption applications) are intended to operate in secured environments and a fingerprint sensor is particularly recommended for security. The fingerprint recognition-based security function and the random signal generation function are therefore advantageously combined using a single sensor for a different kind of security (security by encryption, in particular). Even better, the invention can enable the fingerprint itself to be encrypted (before transmission to a decryption, recognition and authentication system), the fingerprint reading itself being used to create the random sequence used to encrypt the fingerprint.

Preferably, the order of the low order bits from the analog-to-digital converter is scrambled to limit the correlations between adjacent detectors (or pixels) or between adjacent rows.

### BRIEF DESCRIPTION OF DRAWING

Other features and advantages of the invention will become apparent from reading the detailed description that follows, and which is given in reference to the appended drawings, in which the single figure represents the random sequence generator according to the invention.

### DESCRIPTION OF ILLUSTRATIVE EMBODIMENTS

An individual pyroelectric detector is formed by a ceramic or plastic such as PVDF (polyvinylidene fluoride) or ceramic pyroelectric (or piezoelectric, which amounts to the same thing) layer, forming an individual capacitor connected to a read circuit which amplifies the signal. The signal is then converted into digital form by the converter. The signals from the various detectors or pixels in a row are read sequentially and the signals from the various rows are also read sequentially.

When no finger is touching the sensor, each pixel is approximately in thermal balance with its environment, taking into account the external temperature and the power consumption of the integrated circuit chip bearing the detectors.

However, the pyroelectric layers are extremely sensitive to external disturbances; a breath of air, a noise, a vibration, can easily alter the charge level and therefore the level of the signal read and converted. The electronic noise is added to that. These disturbances exist in the absence of a main signal due to the presence of a finger, but they are added to the main signal when it exists.

The random noise source will be formed by the least significant bit of the analog-to-digital converter, in the presence or in the absence of a main signal. Furthermore, the various pixels, of which there are many since it is a question of reading a fingerprint, will be used, the signals from these pixels being broadly decorrelated between themselves and this all the more so when they are not juxtaposed.

The Figure represents the system according to the invention. The fingerprint sensor 10 is seen in cross section; it is a silicon chip including a matrix of pyroelectric capacitors in an area 10 on which a finger can be placed or swiped. The chip has its own means of addressing the matrix, of reading the signals from the matrix, of amplifying and of providing analog-to-digital conversion. These means are represented outside the chip for greater ease of representation.

The matrix includes, for example, eight rows of 280 pixels each, and is read periodically in 1 millisecond. The signal read is amplified and converted into digital form by the converter. A converter with a 4-bit resolution is sufficient to take the fingerprint image, but a higher resolution converter can be provided to enhance the random nature of the least significant bit.

As a general rule, every effort will be made, in the system design, to ensure that the level of amplification of the signal read is sufficient for the natural noise (thermal, electronic, etc.) to be greater than the level of the least significant bit in order for the latter to toggle randomly.

It is this least significant bit at the output of the analog-to-digital converter 14 which is used to form a random sequence of bits.

However, preferably, the sequence is not sampled directly at the output of the converter 14. Rather, it is preferably taken at the output of a pixel reorganization circuit 16. The reorganization circuit 16 is preferably also located on the fingerprint sensor chip.

The reorganization circuit 16 takes in turn the low order bits from the converter 14, which arrive in the order of addressing of the fingerprint detection matrix, that is, row by row and, within a row, in the order of the columns of the matrix. The reorganization circuit 16 scrambles the order of the bits received from the converter so that the bits from adjacent pixels in the matrix are not adjacent in the order of the random sequence. This avoids correlations in the sequence.

In any case, the function of the reorganization circuit is to eliminate most of the known correlations, correlation between adjacent pixels or other correlations. For example, the reorganization circuit should not allow the bits of one and the same column from a number of rows of the matrix to pass successively. In practice, there is in theory a correlation between the different rows since they need to see the same image at different instants.

Furthermore, the reorganization circuit is followed by a circuit or software means 18 for adjusting the average distribution of the bits, that is, over an average period, the sequence should include as many 0 bits as there are 1 bits. This is done by a relatively simple algorithm. The bits from the first reorganization (resulting from the scrambling of the order of the pixels) are read in twos. When the bits are both at 0 or both at 1, they are quite simply disregarded. When the first is at 0 and the second is at 1, a 1 bit is generated; in the opposite case, a 0 bit is generated (or the reverse, naturally).

This makes it possible, at least as a first approximation, to obtain as many 0 bits as there are 1 bits, because if the random source is badly distributed and produces more 0 bits than 1 bits (for example), then the combination 00 should statistically appear more often and the combination 11 less often. Since these two combinations are eliminated, only the other two are left, and there is no reason for them to be distributed abnormally.

However, for the case where the distribution would still be abnormal, it is preferable to provide in addition for the above conversion to be periodically alternated; thus, for a series of pairs received, 01 or 10, the conversion transforms 01 into a 1 bit and 10 into a 0 bit, but for the subsequent series of pairs, the conversion transforms 01 into a 0 bit and 10 into a 1 bit, and so on. The conversion can even be alternated on each pair, that is, it is inverted for each bit of the random sequence produced.

The selecting of pixels to produce a pair of successive bits is done by the reorganization circuit so as to avoid the correlations, and it is advantageously proposed for this to use, for each pair, a pair of remotely separated pixels; for example the pixel at a left end of a row of the matrix is taken at the same time as the pixel in the middle of the row, then there is a shift by one step to the left to take a new pair, the second pixel starting from the left with the second pixel starting from the middle, and so on.

Other possibilities can be provided for, the principle being to avoid a correlation identified as being possible.

If the random sequence does not require a rapid production, the use of all the pixels in the row can be avoided in favor of using only certain of them, by changing the group of pixels used on each image line scan. This increases the random nature (at the cost of speed, since more lines are needed for the same random sequence length).

In order to protect the random sequence generator against any external spurious effects, preferably a control circuit or software 20 is added, in the form of a circuit or periodic self-test software used to check for correct operation. The self-test relies on the periodic verification of the distribution of the signal values from the fingerprint pixels. This can be done by calculating the mean of the signal over the image which should be neither zero or high enough for it to probably result in saturation of the sensor. Also, a standard deviation calculation can be carried out between the signal values from the various pixels: the standard deviation should have a value that is neither too low (there is no reason why the pixels should all provide the same signal level) nor too high (signifying that something abnormal is acting on the sensor). It is also possible to monitor a histogram of values (checking for the absence of gaps or discontinuities in the histogram, etc.).

Finally, it is possible to check that the values of the pixels vary over time, that is, that it is not always the same image pattern that is read by the sensor.

This makes it possible to check that there are no “dead” pixels in the image and, if there are any, to ensure that they are eliminated from the random sequence production process.

Although the preferred fingerprint sensor according to the invention is a pyroelectric cell sensor, it is possible to envisage it being a capacitive, or even optical, sensor. In an extreme case, it could be possible to use, to produce a pseudo-random sequence, only a single detector cell and not all of the matrix, but this embodiment is far less interesting.

The random sequence generator disclosed above is particularly useful in a system using encryption means. In particular, means of encrypting the fingerprint that has been detected by the fingerprint sensor. The fingerprint reading is then in turn used to create the pseudo-random sequence that is used to encrypt the transmission of this fingerprint.

1-9. (canceled)

10. A random binary sequence generator comprising:
a main element for generating a physically-originated random sequence,
a fingerprint sensor with a matrix of individual detectors,
said fingerprint sensor including an analog-to-digital converter for converting the voltage levels detected by the individual detectors into digital form, and the low order bits of this conversion being used to form the bits of the pseudo-random sequence.

11. The random sequence generator as claimed in claim 10, wherein the individual detectors are pyroelectric cells.

12. The random sequence generator as claimed in claim 10, wherein the sensor is a scanning sensor, the matrix being made up of a few rows of numerous detectors, for detecting a fingerprint when a finger is swiped over the surface of the sensor.

13. The generator as claimed in claim 10, including means for scrambling the order of the bits to reinforce the random nature of the sequence.

14. The generator as claimed in claim 13, including means for sampling successive pairs of low order bits, to eliminate the 00 pairs and the 11 pairs, and to convert a 01 pair into a first bit and a 10 pair into an inverse bit, to form a sequence with a better distribution of 0 and 1 bits.

15. The generator as claimed in claim 14, wherein the conversion is inverted between two successive series of 01 and 10 pairs, a first conversion mapping the 01 pair to a 0 bit and an inverse conversion mapping the 01 pair to 1.

16. The generator as claimed in claim 15, wherein the conversion is inverted on each new pair of bits.

17. The generator as claimed in claim 10, including a means of verifying the image of the fingerprint, this means including in particular a means of verifying the value of the mean and/or the standard deviation of the signal values from the various individual detectors.

18. The random sequence generator as claimed in claim 11, wherein the sensor is a scanning sensor, the matrix being made up of a few rows of numerous detectors, for detecting a fingerprint when a finger is swiped over the surface of the sensor.

19. A system comprising a generator as claimed in claim 10 including means of encrypting a fingerprint detected by a fingerprint sensor, these means using the random sequence generator.
